(19) United States
(12) Patent Application Publication
(10) Pub. No.: US 2015/0309984 A1
(43) Pub. Date: Oct. 29, 2015

(54) LEARNING LANGUAGE MODELS FROM SCRATCH BASED ON CROWD-SOURCED USER TEXT INPUT

(71) Applicant: Nuance Communications, Inc., Burlington, MA (US)

(72) Inventors: Ethan R. Bradford, Seattle, WA (US); Simon Corston, Newminster (CA); Donni McCray, Seattle, WA (US); Ryan N. Cross, Seattle, WA (US)

(73) Assignee: NUANCE COMMUNICATIONS, INC., Burlington, MA (US)

(21) Appl. No.: 14/262,304

(22) Filed: Apr. 25, 2014

(51) Int. Cl. G06F 17/27; G06F 17/28

(52) U.S. Cl. CPC G06F 17/275; G06F 17/28

(57) ABSTRACT

Technology is described for developing a language model for a language recognition system from scratch based on aggregating and analyzing text input from multiple users of the language. The technology allows a user to select a language, and if no existing language model is available for the selected language, provides a new language model for the selected language, monitors and collects information about the use of words in the selected language, combines information collected from multiple users of the selected language, and updates the user's language model based on the combined information from multiple users of the selected language.

### BACKGROUND

As electronic devices become increasingly widespread and sophisticated, users of such devices around the world enter text in various languages. A wide variety of language recognition systems are designed to enable users to use one or more modes of input (e.g., text, speech, and/or handwriting) to enter text on such devices. For supported languages, language recognition systems often provide predictive features that suggest word completions, corrections, and/or possible next words.

Language recognition systems typically rely on one or more language models for particular languages that contain various information to help the language recognition system recognize or produce those languages. Such information is typically based on statistical linguistic analysis of an extensive corpus of text in a particular language. It may include, for example, lists of individual words (unigrams) and their relative frequencies of use in the language, as well as the frequencies of word pairs (bigrams), triplets (trigrams), and higher-order n-grams in the language. For example, a language model for English that includes bigrams would indicate a high likelihood that the word “degrees” will be followed by “Fahrenheit” and a low likelihood that it will be followed by “foreigner”. In general, language recognition systems rely upon such language models—one or more for each supported language—to supply a lexicon of textual objects that can be generated by the system based on the input actions performed by the user and to map input actions performed by the user to one or more of the textual objects in the lexicon. Language models thus enable language recognition systems to perform next word prediction for user text entry.

Once a language model has been developed for a language and provided to users, language recognition systems typically allow users to build on or train their local language models to recognize additional words in that language according to their individual vocabulary use. The language recognition system may thus improve on its baseline predictive ability for a particular user.

### BRIEF DESCRIPTION OF THE DRAWINGS

FIG. 1 is a block diagram showing some of the components typically incorporated in at least some of the computer systems and other devices on which the technology is implemented.

FIG. 2 is a system diagram illustrating an example of a computing environment in which the technology may be utilized.

FIG. 3 is a flow diagram illustrating a set of operations for identifying a language and providing a new language model to a user.

FIG. 4 is a flow diagram illustrating a set of operations for building a language model based on crowd-sourcing multiple users' language model events.

FIG. 5 is a diagram illustrating an example of language model updates based on text entered by multiple users.

FIG. 6 is a table diagram showing sample contents of a user device and language table.

### DETAILED DESCRIPTION

The headings provided herein are for convenience only and do not necessarily affect the scope or meaning of the claimed invention.

### Overview

Language models have been developed for dozens of the world's major languages, including, e.g., English, French, and Chinese. In an ideal world, language models would be available on a user's electronic device for every language in the world. Linguists estimate, however, that over seven thousand languages are used around the world. Language models have not been developed for the vast majority of languages; those languages are therefore not yet supported by traditional language recognition systems.

In the field of language recognition systems, supporting more languages is a potentially valuable market differentiator. In addition to the straightforward utility that support for a particular language provides to groups who use that language, the total number of languages supported is a simple, easily compared metric. By supporting languages that were previously unlikely to be supported, a company (e.g., a speech recognition software provider, a computer manufacturer, or a mobile phone carrier) can claim to offer the broadest language support, can serve localized populations, can create product interest for end users, can open new markets, and can attract population-specific media attention.

A variety of conventional approaches exist for creating a new language model. A first is, for a language in which a significant amount of representative writing is available via the Internet, to collect and analyze that corpus of writing. Such analysis could include, e.g., counting common words and n-grams; classifying words; and detecting and eliminating profanity and/or other undesirable vocabulary.

Another widely used conventional approach to creating a new language model is to locate native speakers with linguistic talents to determine common and useful words, find or generate a representative text corpus, and refine lists of words that may be generally used.

Yet another conventional approach to obtaining a language model for a new language is to purchase a dictionary from someone who has already made the necessary effort to create it; additional verification or refinement may also be necessary.

The inventors have recognized that the conventional approaches to providing new language model support for language recognition systems have significant disadvantages, especially in the context of minority languages. For instance, language models for most languages that have a Web presence have already been developed. For other languages it may be difficult to find a corpus of text on the Web, let alone a corpus of sufficient size for generating a language model. For example, informal messages using Latin-alphabet transliterations of non-Latin-alphabet languages are a widespread phenomenon. Because such messages are informal, however, it is hard to find a significant corpus of them to analyze. It may be even more difficult to exclude highly technical, vulgar, and misspelled words (among other undesirable data), and to limit data analysis (e.g., of word and n-gram frequency) to text that is likely to be representative of the input expected from users of electronic devices having a language recognition system. Therefore the Internet writing analysis approach may not be available, workable, or reliable for a particular language.

The approach of producing a word list for a language by hand with the assistance of native speakers has the disadvantages that it is labor-intensive and requires native speakers with linguistic talents to locate or generate and analyze a native text corpus including wordlists and counts. It may be difficult to contract a language expert for minority languages. Even if such resources are available, hiring experts to develop a dictionary and related language model data for a previously unsupported language can be prohibitively expensive and time-consuming. For languages with small numbers of speakers, the costs may exceed the potential return on investment. Similarly, buying a dictionary from someone else who has made those efforts may not be economically feasible.

In a broader context outside the field of language recognition system language models, volunteers have devoted time and resources to develop general open-source dictionary projects such as Wiktionary and the OpenOffice spell-check dictionary. Participation in such dictionary editing projects, however, requires a high level of motivation, free time, and technological skill (e.g., to edit lexical files for spell-checking). Those factors create a high bar for volunteer participation in such projects; as a result, only a few dedicated people devote themselves to such work. Thus, like the approach of producing a word list for a language by hand with the assistance of native speakers, the open source volunteer-driven approach is labor-intensive and time-consuming. In addition, it may not be possible to rely on the existence, participation, and commitment of qualified volunteers to systematically edit dictionary files for a particular language.

In view of the shortcomings of conventional approaches to providing new language model support for language recognition systems, especially in the context of minority languages with limited numbers of native speakers, the inventors have recognized that a new approach to developing language models that is more universally applicable, less expensive, and more convenient would have significant utility.

Technology will now be described that builds a language model for language recognition systems from scratch based on capturing text entered on electronic devices by multiple users in the language to be supported. The technology builds up lexical resources based on analysis of crowd-sourced language usage. It allows those lexical resources to be consolidated and provided to people who speak a large number of the world's languages where such resources would otherwise be unavailable.

By gathering words and frequency counts for new target languages, based on real-world language usage that is directly relevant to the development and application of the desired language model, the technology dramatically increases the ability to produce a new language model for almost any actively used language.

Allowing Users to Identify a Language without a Language Model

The technology allows a user to input text in a language for which there is no preexisting language model or word list from which the language recognition system could predict words for the user. In some implementations, the technology requires the user to identify the language being used. In some implementations, the technology prompts users to choose among recognized languages for which a language model has been developed and also allows users to specify new languages, either by choosing from a set of targeted languages or by defining the language name themselves. For example, the technology may allow the user to select a language from a menu of languages via a pull-down list.

The technology may allow the user to pick a language that does not (yet) exist in such a selection list by typing or otherwise inputting a language name in a free-form text field. In some implementations, the technology alerts the user that a language choice is new, that predictive features (e.g., spelling correction) are not fully supported in the chosen language, and/or that the user's text input will help develop a language model for the chosen language. In some implementations, the technology allows a user to choose a language but opt out of crowd-sourcing (sharing information about the user's language use and/or receiving updates based on other users' language use), e.g., so that a user can keep custom word additions separate on the user's device.

Automatic Language Detection

In some implementations, the technology identifies or helps a user to identify a chosen language. For example, the technology can use geolocation information about the user or the electronic device and information about languages spoken in or around that location to suggest languages that may be relevant to a user in that location. In some implementations, the technology analyzes text input to identify characteristics that may indicate the user is typing in a particular language, even if a full language model for that language has not been developed. When such characteristics are identified, the technology may suggest that the user choose to identify their input as input in a particular language. In some implementations, the technology identifies the language without requiring the user to identify their input as input in a particular language, thus minimizing burden to the user. Such identification may be based on, e.g., common clusters of words and n-grams used, word frequencies, keyboard choice, and/or other characteristics of the user's input. The technology can group users employing the same or similar languages, even if a user has not specifically selected the language used, or if a user has misidentified the language used. For example, Tagalog (or Filipino) is the national language of the Philippines, and Cebuano is another language spoken by approximately twenty million people in the Philippines. The technology can identify a user whose keyboard is set to Tagalog but who is actually typing Cebuano (whether the user has, e.g., not affirmatively selected a language, chosen Tagalog, or chosen English), and provide an appropriate language model.

Encouraging Same-Language Selections

Some users may input different names or terminology to identify a particular language. In some implementations, the technology guides or encourages users to choose the same name for each language so that as many users as possible are contributing to the development of the same language model. For example, the technology may guide users to choose, in order of priority, the name of a language with an existing language model, the name of a language with a developing language model (e.g., a word list growing as a result of users utilizing the technology), or the standardized name of a language with no available language model. For example, the Ethnologue, published by SIL International, provides a comprehensive, standardized list of languages of the world.

In some implementations, the technology guides users to English names of languages. For example, the language of Finland could be listed as “Finnish”, as opposed to “Suomi”. In some implementations, the technology displays the native names of languages for ease of recognition by users of a language (in many languages, the name of the language is just the word “language”; for example, Māori speakers call the Māori language “Te Reo” (“the language”)). In some implementations, the technology lists languages in the electronic device's native language, e.g., in English for a device offered in the United States, or in Japanese for a device offered in Japan.

In some implementations, the technology recognizes or utilizes alternative names for a language. For example, Cebuano may also be known as Binisaya or Visayan. The technology may recognize all three names for Cebuano. In some implementations, the technology displays alternative names for a language to a user to verify that the chosen language is the language intended by the user, or allows the user to choose a language name from a list. In some implementations, the technology recognizes at least English and native names for a language. In some implementations, the technology corrects misspellings or otherwise regularizes a non-standard name of a language provided by a user, or asks the user whether a similar standardized name was actually intended. In some implementations, the technology prompts a user who chooses a new language to provide alternate language names and/or a description of the language or of where it is commonly used. The technology can build a table of language and dialect names from known language name variants, e.g., from the Ethnologue and from users who provide alternate names when they choose a new language.

Connecting Related Languages and Language Names

For various reasons, users may wish to use different names for a language. For example, Catalan and Valencian share a common vocabulary. Mutually intelligible dialects may likewise use all, or almost all, words of a language in common. The technology can cross-link different language names to share the same word list. By allowing users to share a language model (or a portion of a language model), the technology can develop the language model more efficiently. The technology can also augment such sharing regarding related languages by analyzing word lists and identifying languages and dialects that have significant overlap in their word frequency distribution. In some implementations, the technology allows related languages to use a lexicon of shared words as well as dividing out separate lists of terms that are language-specific. For example, different Norwegian dialects that are generally mutually intelligible use different words for the pronoun “we”. The technology can identify and share words used by all of the dialects, and determine that users who have chosen different dialects choose different pronouns.

Thus, by reducing duplication, the technology allows a user to enter text in various languages and dialects while minimizing conflicts between related languages and minimizing storage space required on the user's electronic device. In some implementations, the technology allows users choosing to initiate a language model for a new language to choose a base language to start with. In that case, the technology can start the user with a database of words or a complete language model from the base language rather than a blank slate. In some implementations, the technology identifies that a base language model is related to the user's language and provides at least a portion of the base language model as part of or in addition to a language model for the user's language.

By supporting the development of language models for minority languages, the technology is relevant to speakers and proponents of those languages; for example, immigrant communities, organizations supporting the preservation of dying languages, and governmental and private-sector language standardization and promotion authorities and advocacy groups. The technology also allows users to generate language models for other purposes and less formal language applications. For example, spoken dialects such as Swiss German (Alemannic dialects) may differ from written forms such as Swiss Standard German. The technology allows users of such dialects to develop a language model reflecting their actual usage as opposed to conforming their usage to a standard for written language. Where input may be a combination of informal text entry and voice transcription, the technology allows users to potentially develop a model reflecting a non-standard but real-world useful mix of vocabulary and orthography.

Similarly, the technology allows users to create new language designations. For example, users may choose to build a language model for one or more forms of chatspeak (aka txtese, netspeak, SMSish, etc.) to reflect and predict that extremely condensed and abbreviation-heavy form of communication. Though chatspeak may tend to be popular among users in particular demographic groups, it might not be considered a typical target as a separate language candidate for development of a language model. Therefore, the technology gives users the potential to democratize language model development. The technology may thus bring additional goodwill from user groups who wish to have better language recognition system support for their particular uses. Other potential applications include synthetic languages (e.g., Klingon), jargon-heavy vocabulary (e.g., legalese), hybrid or code-switching language (e.g., “Spanglish” mixing Spanish and English), and dialects, whether recognized or not. Additionally, the technology allows the crowd-sourced standardization of some written language forms. For example, although there are some standard transliterations for chatspeak in Arabic, they are not part of a developed language model and many individuals improvise their own transliterations. By recording and sharing actual usage and corrections from a multitude of users, the technology can lead some basic accepted forms to emerge from chaotic individual usage.

Character Sets and Keyboards

In some implementations, the technology allows or requires users to choose, along with a language name, an associated character set and/or a keyboard for entering the characters of the chosen language. A large number of languages can be supported with an English QWERTY keyboard for Latin or Roman script characters. For example, a keyboard of Latin characters allows users of languages that are not naturally in a Latin alphabet to enter text in transliteration using Latin script.

In some implementations, the technology provides or offers as an alternative a Latin universal keyboard through which a user can easily obtain many letter variants (e.g., various accented “e” characters), or a Unicode universal keyboard that additionally provides access to non-Latin characters. The technology maps, or allows users to map, various Unicode characters to the different keys of a keyboard, particularly for a virtual keyboard of a touch-screen display. Other keyboards and character sets may be available on the user's electronic device. In some implementations, the technology provides a dialog or other selection interface for choosing a character set and appropriate keyboard. The technology may offer the user potential selections of keyboards and character sets of related languages. If a selected keyboard or character set is not available on the user's electronic device, the technology can download it to the electronic device.

In some implementations, each language is associated with exactly one keyboard. The associated keyboard may be assigned to the language, may be selected by the user from two or more keyboards (e.g., keyboards containing character layouts appropriate for the language), or may be user-designed. In some implementations, each language is associated with at least one keyboard. In some implementations, the technology determines what keyboard most users of a language choose, and provides or suggests that keyboard as a default choice. The technology thus uses crowd-sourcing among the users of a particular language to determine one or more preferred or ideal keyboard layouts for that language. In some implementations, the technology includes collaborative tools (e.g., a wiki) for users to collectively create, edit (e.g., by assigning specific Unicode characters to specific keys), and share one or more keyboard layouts for a language. In some implementations, the technology allows users to quickly switch between different keyboard layouts for the same language or between keyboards containing the same or different characters for different languages. In some implementations, the technology allows a user to obtain characters from different languages on a single keyboard. For example, upon a distinctive user gesture such as a press-and-hold action on a key, the technology may display and allow a user to enter characters from other languages or character sets (e.g., Cyrillic or Japanese characters from a Latin keyboard).

Native and Transliterated Text

In some implementations, the technology accommodates users who wish to develop language models for a language using different character sets. For example, two users might wish to enter Cherokee text: one in transliteration with Latin characters, and one using a Cherokee alphabet script. In some implementations of the technology, a language model stores both native and transliterated versions of words for a particular language in one dictionary. The technology can separately identify words entered by users who are using different scripts, so that a user typing in native script will not be surprised by a suggested transliterated word (particularly a Latin script word that native script users do not typically enter). In some implementations, the technology converts transliterated words entered using Latin characters into native script words, or provides users an option to do so. In some implementations, the technology segregates language models utilizing different scripts and provides two or more separate language choices (e.g., one native script language model and one transliterated or “-latin” version language model). In some implementations, the technology relates common words entered in different scripts and updates the language model or models, e.g., to include more comprehensive word frequency information. In some implementations, the technology allows users of native or transliterated text to exclude storage of words in the script they are not using, to conserve storage space on the electronic device.

The technology accommodates words entered using characters from more than one language or script. For example, a user might combine Russian (Cyrillic script) and English (Latin script) characters in the words “ [symbol] ” (the Yandex search engine) or “ [symbol] ” (an adjective form of “IBM”). In some implementations, the technology treats such words with letters from other scripts just like other words entered in the user's active language model.

In general, the technology allows users to specify, with much greater flexibility than previously possible, the language that they are entering text in, and to switch between languages and keyboards. As users express themselves in their chosen languages, the technology saves information about the frequency of the words they use and about the new words they employ in the languages those words are associated with.

Reporting and Sharing Language Usage Information

In some implementations, the technology requires only enough memory to store language model data (e.g., words and frequency counts) and at least occasional connectivity to share information about the user's language usage and receive information from other users of the same language to update the user's language models. In some implementations, the technology takes advantage of higher levels of available memory and connectivity (e.g., on smartphones with high speed data connections) to provide, for example, expanded language model capacity, multiple simultaneously available language models, automatic detection of different languages, and/or more frequent language model updates.

The technology builds a language model by monitoring and analyzing the vocabulary use of users who have chosen a particular language on an electronic device with the technology. In some implementations, the technology identifies user actions regarding a new or developing local language model including word additions, word deletions, changing frequencies of using words or n-grams, responses to word suggestions, changes in word priorities, and other events tracked in the local language model. In some implementations, the technology observes and records only the words used by a user and the frequency of use of each word. In some implementations, the technology allows users to augment a language model with additional words by explicitly adding words to a user dictionary in addition to observing a user's vocabulary usage patterns.

When users use or save new words that are not yet provided in the chosen language model, the technology transmits (or prompts the user to transmit) the updated language model or the incremental updates to that model. The technology may collect the updates in a central repository or on a distributed or peer-to-peer basis among other users. The technology analyzes multiple users' language models for a language, identifying and counting the words that users are using, and adding some user-added words to the user's language model and returning the updated language model to the user. In some implementations, the technology allows a user to receive language model updates based on aggregated usage information without requiring the user to upload or otherwise share the user's own language model or data. In some implementations, when a user has few words in the user's local language model, the technology is more generous in adding words used by other users. By leveraging many users' vocabulary usage, the technology can organically grow an empty new language model from scratch to, e.g., an individual user's hundreds of initial words to a shared language model containing tens of thousands of words.

Thresholds

In some implementations, the technology requires a minimum number of different users to employ the same word before adding that word to a language model for sending other users. By requiring a threshold breadth of usage (e.g., three or ten separate users), the technology improves the likelihood that a word is generally useful. The technology also decreases the likelihood of sharing private information, because different users are unlikely to use the same word if it is one user's private data. In some implementations, the technology identifies words unlikely to be private, like very short words (e.g., one- and two-letter words), and accepts such words for sharing among users building a language model at a lower user threshold. In some implementations, the technology raises a threshold for accepting short words for sharing, or uses as a threshold a minimum proportion of users using a word instead of or in addition to a minimum number, to ensure that common short words are included in the language model but erroneous short character strings are not. In some implementations, the technology sets a lower threshold for users who are early adopters developing a language model with few or no words or with few other users entering text in that language, and tightens the standard as the language model grows in size or popularity. In some implementations, the technology sets a lower threshold for a language with complex morphology in which word forms are specific and only used occasionally.

Implicit Word Learning

In some implementations, the technology collects all words used by a user, so that the user is not required to manually add words to a local dictionary. In some implementations of the technology, newly used words are added to the language model provisionally, providing a quarantine period to prevent misspelled words or other accidental text entry from becoming a top match right away. The technology can limit its behaviors regarding quarantined words, e.g., by gathering usage statistics normally but being cautious about whether to show such words in a pick-list of suggested words. In some implementations, the technology includes user-adjustable quarantine settings. Once a new word has been used enough so that it is sufficiently unlikely to be an unintended error, the technology removes the quarantine designation, allowing the word to be presented as a user suggestion and uploaded to other users' language models for the language. In some implementations, if others participating in the development of the same language model are using the same word, after the upload and download process the technology will add word (or its correct or complete form according to general usage) to the user's language model, out of quarantine.

In some implementations, the technology allows a user to turn off implicit learning of words used by the user in general or in a specified language. If implicit learning is turned off, the technology can explicitly ask, for each unrecognized word, whether the word should be added to the dictionary of the new language model.

In some implementations, the technology leverages the set of words entered in a language model by a user or users, using those words (or n-grams) as a seed to search the Web for related words. In that manner, the technology may locate a previously unknown corpus of related text in the language in question. The technology may add those words (possibly designating them as provisional or quarantined) and/or information about their usage (e.g., in n-grams or word frequency) to the user's language model.

Allowing Users to Submit Additional Text

In some implementations, the technology allows users to select or otherwise provide a block of text to scan in order to add it all to the user's language model for a particular language. The technology thus allows passionate users (e.g., language evangelists) to contribute, in crowd-sourced fashion, their own corpus that might not be generally available. For example, a user could provide a document written in that language on a tablet, or play a recording of speech in that language on a phone with voice recognition software, adding it all to be scanned for new words and word frequency counts.

Filtering

In some implementations, as the shared vocabulary in a language grows, the technology performs some corrections within the language model, without linguist intervention. The technology can therefore help users to avoid many typographic errors. In-list spelling correction can correct any error types for which there is an error type model. For example, the technology can replace transposition errors (such as correcting hte to the) by checking the frequency that users of a language employ each word. For instance, “hte” is rare whereas “the” is the most common English word. If the ratio indicates that a word is very likely an erroneously transposed version of a common word, the technology can correct the error or quarantine the apparently incorrect word.

The technology can also correct, e.g., unaccented versions of accented words (such as correcting cafe to café). For example, many users prefer to type without special characters (e.g., facade instead of façade), relying on the language recognition system to auto-correct the entered text by picking the correct form from the language model. If multiple users type words without special characters when building a new language model, the model could learn incorrect forms of those words. In some implementations, the technology recognizes this user behavior and treats word forms containing special characters as more authoritative than similar forms without special characters, especially if a language recognition system suggests the version without special characters and some users manually correct it to a version with special characters.

In some implementations, the technology observes what words users often delete or change, and identifies them as misspelled or otherwise unwanted for the language model (e.g., improperly punctuated or capitalized, pornography-related, or profane words). In some implementations, the technology applies a list of words or patterns (e.g., URLs of objectionable Websites, numeric digits, and symbols) for removal from language models including models being developed for new languages. For example, the technology can identify by pattern and expunge from language models various sensitive information including email addresses and number strings (or numbers with punctuation) such as telephone numbers and credit card numbers. In some implementations, the technology excludes anything that a user entered in a password field from the information used to build a language model.

Polishing

By gathering data about users' actual use of languages and accumulating statistics about that use through crowd-sourcing, the technology can identify basic accepted words and forms, generating probabilities of the most common words and the most commonly used spelling for each word. With sufficient numbers of users and amounts of text input, the technology can distill more sophisticated linguistic information from the user-generated corpus. In some implementations, the technology can enable users to create a written equivalent even for a purely spoken language with no traditional written form.

In some implementations, the technology provides administrative or super-user rights to one or more users of a language. For example, the technology may identify users with the largest number of corrections or words entered in a language, and allow or invite such users to resolve inconsistencies or ambiguities in the language model. For example, the technology may identify a set of words or word forms that are substantially similar (and, e.g., used in similar ways and contexts), and ask the super-user to arbitrate between competing choices or designate one or more as correct or incorrect. The technology may request a super-user to review vocabulary for profanity, non-standard orthography, contamination from other languages, and other undesired content. The technology may solicit such corrections from multiple users and crowd-source the corrections of such possible experts by requiring a threshold level of agreement between such users before applying the corrections to the language model. The technology may provisionally apply such corrections to the language model and reverse them if a significant number of users undo the provisional corrections. The technology may allow users to self-identify linguistic experience, expertise, or authority, or to request to be treated as experts in the language. The technology may give less weight to edits by or revoke super-user status from users whose quality control corrections are unpopular.

Once a crowd-sourced language model developed according to an implementation of the technology reaches a threshold level of size, stability, and utility for accurate next word prediction in the language, the language model can be treated as substantially complete or equivalent to a language model developed according to conventional approaches.

### DESCRIPTION OF FIGURES

The following description provides certain specific details of the illustrated examples. One skilled in the relevant art will understand, however, that the technology may be practiced without many of these details. Likewise, one skilled in the relevant art will also understand that the technology may include many other obvious features not described in detail herein. Additionally, some well-known structures or functions may not be shown or described in detail below, to avoid unnecessarily obscuring the relevant descriptions of the various examples.

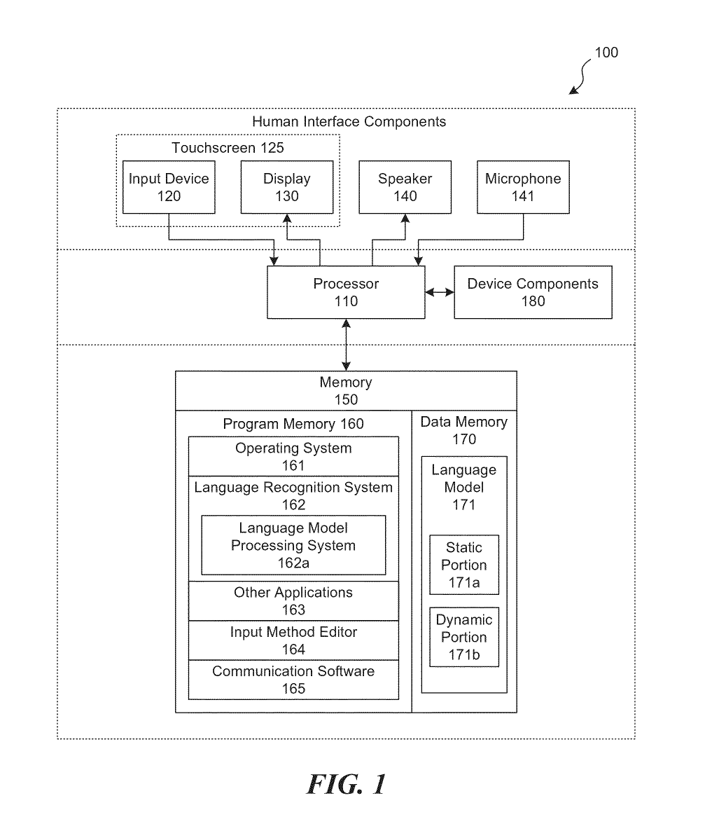

FIG. 1 is a block diagram showing some of the components typically incorporated in at least some of the computer systems and other devices on which the technology is implemented. A system 100 includes one or more input devices 120 that provide input to a processor 110, notifying it of actions performed by a user, typically mediated by a hardware controller that interprets the raw signals received from the input device and communicates the information to the processor 110 using a known communication protocol. The processor may be a single CPU or multiple processing units in a device or distributed across multiple devices. Examples of an input device 120 include a keyboard, a pointing device (such as a mouse, joystick, or eye tracking device), and a touchscreen 125 that provides input to the processor 110 notifying it of contact events when the touchscreen is touched by a user. Similarly, the processor 110 communicates with a hardware controller for a display 130 on which text and graphics are displayed. Examples of a display 130 include an LCD or LED display screen (such as a desktop computer screen or television screen), an e-ink display, a projected display (such as a heads-up display device), and a touchscreen 125 display that provides graphical and textual visual feedback to a user. Optionally, a speaker 140 is also coupled to the processor so that any appropriate auditory signals can be passed on to the user as guidance, and a microphone 141 is also coupled to the processor so that any spoken input can be received from the user, e.g., for systems implementing speech recognition as a method of input by the user (making the microphone 141 an additional input device 120). In some implementations, the speaker 140 and the microphone 141 are implemented by a combined audio input-output device. The system 100 may also include various device components 180 such as sensors (e.g., GPS or other location determination sensors, motion sensors, and light sensors), cameras and other video capture devices, communication devices (e.g., wired or wireless data ports, near field communication modules, radios, antennas), and so on.

The processor 110 has access to a memory 150, which may include a combination of temporary and/or permanent storage, and both read-only memory (ROM) and writable memory (e.g., random access memory or RAM), writable non-volatile memory such as flash memory, hard drives, removable media, magnetically or optically readable discs, nanotechnology memory, biological memory, and so forth. As used herein, memory does not include a propagating signal per se. The memory 150 includes program memory 160 that contains all programs and software, such as an operating system 161, language recognition system 162, and any other application programs 163. The program memory 160 may also contain input method editor software 164 for managing user input according to the disclosed technology, and communication software 165 for transmitting and receiving data by various channels and protocols. The memory 150 also includes data memory 170 that includes any configuration data, settings, user options and preferences that may be needed by the program memory 160 or any element of the system 100.

The language recognition system 162 includes components such as a language model processing system 162a, for collecting, updating, and modifying information about language usage as described herein. In some implementations, the language recognition system 162 is incorporated into an input method editor 164 that runs whenever an input field (for text, speech, handwriting, etc.) is active. Examples of input method editors include, e.g., a Swype® or XT9® text entry interface in a mobile computing device. The language recognition system 162 may also generate graphical user interface screens (e.g., on display 130) that allow for interaction with a user of the language recognition system 162 and the language model processing system 162a. In some implementations, the interface screens allow a user of the computing device to set preferences, provide language information, make selections regarding crowd-sourced language model development and data sharing, and/or otherwise receive or convey information between the user and the system on the device.

Data memory 170 also includes one or more language models 171, which in accordance with various implementations may include a static portion 171a and a dynamic portion 171b. Static portion 171a is a data structure (e.g., a list, array, table, or hash map) for an initial word list (including n-grams) generated by, for example, the system operator for a language model based on general language use. In contrast, dynamic portion 171b is based on events in a language (e.g., vocabulary use, explicit word additions, word deletions, word corrections, n-gram usage, and word counts or frequency measures) from one or more devices associated with an end user. In accordance with various implementations, for a new language there may be no static portion 171a of the language model 171. The language recognition system language model processing portion 162a modifies dynamic portion 171b of language model 171 regardless of the absence of a static portion 171a of language model 171.

The language recognition system 162 can use one or more input devices 120 (e.g., keyboard, touchscreen, microphone, camera, or GPS sensor) to detect one or more events associated with a local language model 171 on a computing system 100. Such events involve a user's interaction with a language model processing system 162a on a device. An event can be used to modify the language model 171 (e.g., dynamic portion 171b). Some events may have a large impact on the language model (e.g., adding a new word or n-gram to an empty model), while other events may have little to no effect (e.g., using a word that already has a high frequency count). Events can include data points that can be used by the system to process changes that modify the language model. Examples of events that can be detected include new words, word deletions, use or nonuse markers, quality rating adjustments, frequency of use changes, new word pairs and other n-grams, and many other events that can be used for developing all or a portion of a language model. In addition to events, additional data may be collected and transmitted in conjunction with the events. Such additional data may include location information (e.g., information derived via GPS or cell tower data, user-set location, time zone, and/or currency format), information about the language(s) used in a locale (e.g., for determining dialects of language usage), and context information that describes applications used by the user in conjunction with the language processing system (e.g., whether text was entered in a word processing application or an instant messaging application). The additional data may be derived from the user's interaction with system 100.

FIG. 1 and the discussion herein provide a brief, general description of a suitable computing environment in which the technology can be implemented. Although not required, aspects of the system are described in the general context of computer-executable instructions, such as routines executed by a general-purpose computer, e.g., a mobile device, a server computer, or a personal computer. Those skilled in the relevant art will appreciate that the technology can be practiced using other communications, data processing, or computer system configurations, e.g., hand-held devices (including tablet computers, personal digital assistants (PDAs), and mobile phones), wearable computers, vehicle-based computers, multi-processor systems, microprocessor-based consumer electronics, set-top boxes, network appliances, mini-computers, mainframe computers, etc. The terms “computer,” “host,” and “device” are generally used interchangeably herein, and refer to any such data processing devices and systems.

Aspects of the technology can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a local area network (LAN), wide area network (WAN), or the Internet. In a distributed computing environment, modules may be located in both local and remote memory storage devices.

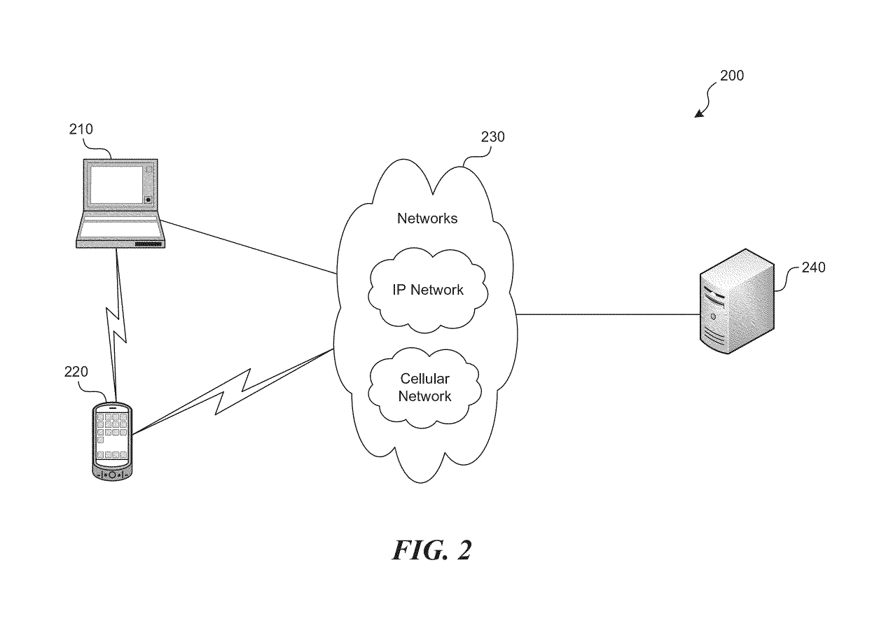

FIG. 2 is a system diagram illustrating an example of a computing environment 200 in which the technology may be utilized. As illustrated in FIG. 2, a system for learning language models from scratch based on crowd-sourced user text input may operate on various computing devices, such as a computer 210, mobile device 220 (e.g., a mobile phone, tablet computer, mobile media device, mobile gaming device, wearable computer, etc.), and other devices capable of receiving user inputs (e.g., such as set-top box or vehicle-based computer). Each of these devices can include various input mechanisms (e.g., microphones, keypads, cameras, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 implementing the technology that coordinates language model information and aggregates information about user input in various languages. System 240 may be maintained in a cloud-based environment or other distributed server-client system. As described herein, user events (e.g., selection of a language or use of a new word in a particular language) may be communicated between devices 210 and 220 and to the system 240. In addition, information about the user or the user's device(s) 210 and 220 (e.g., the current and/or past location of the device(s), languages used on each device, device characteristics, and user preferences and interests) may be communicated to the system 240. In some implementations, some or all of the system 240 is implemented in user computing devices such as devices 210 and 220. Each language recognition system on these devices can be utilizing a local language model. Each device may have a different end user.

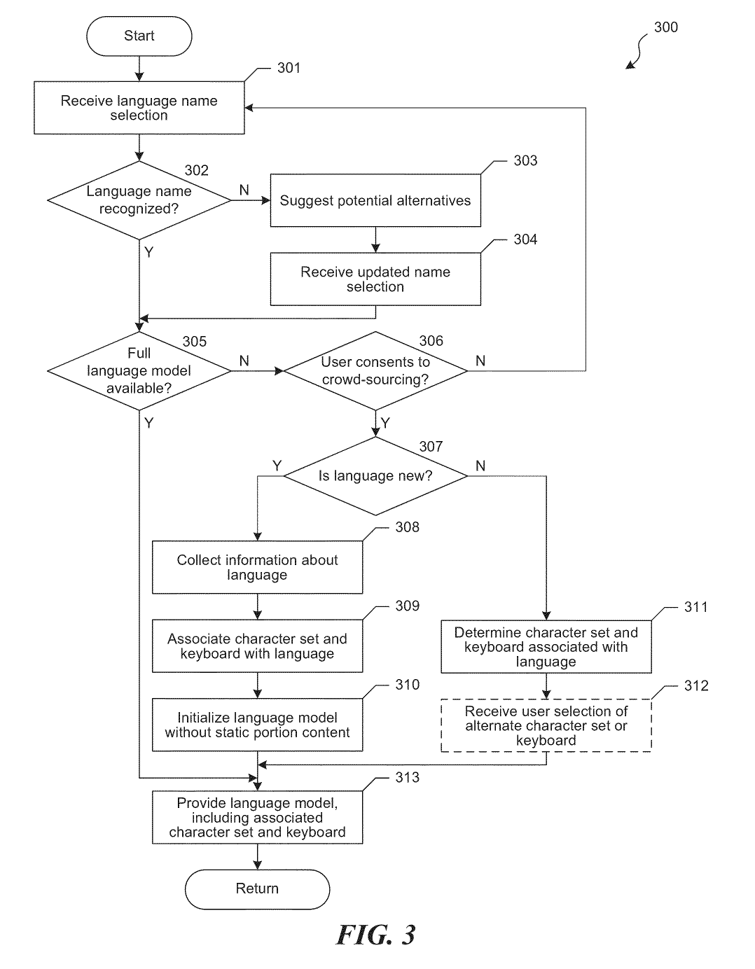

FIG. 3 is a flow diagram illustrating a set of operations for identifying a language and providing a new language model to a user. The operations illustrated in FIG. 3 may be performed by one or more components (e.g., processor 110 and/or language model processing system 162a). At step 301, the system receives a user's selection of a language name. As described above, the system may provide various interfaces to prompt the user's selection, including, e.g., a menu of available languages (and/or languages for which a substantially complete language model is not available) or a field for the user to enter any language name. At step 302, the system compares the language name received from the user to a set of recognized language names. If the language name received from the user is recognized, the process continues to step 305. Otherwise, the process continues to step 303.

At step 303, if the language name is not recognized, the system compares the language name selection received from the user to recognized language names (including any alternative names). For example, a user might mistakenly enter the homophone word “finish” instead of the language name “Finnish”; the system identifies the closely related recognized language name and suggests the correct spelling. It may also suggest alternative intended language choices, e.g., French, or guide the user to choose a language with an existing user base as described above. At step 304, the system receives an updated language name selection, which could include a confirmation of the user's input of an unrecognized language name.

At step 305, the system determines whether an existing language model (e.g., a curated language model including a static portion 171a) is available for the selected language. If such a full language model is available, the process continues to step 313. Otherwise, the process continues to step 306. Alternatively, even if a full language model is available, the system can allow users to participate in crowd-sourced language model development. In step 306, the system obtains the user's consent to participate in language model crowd-sourcing. As described above, obtaining the user's informed consent may include, for example, getting acknowledgement that predictive features (e.g., spelling correction) are not fully supported in a language without a fully developed language model, and making sure that the user is willing to share his or her text input to help develop a language model for the chosen language. If the user does not provide such consent, the process may return to step 301 for the user to choose a different language. If the user consents, the process continues to step 307.

At step 307, the system determines whether the selected language is new, that is, whether any other user has chosen the language, provided basic information, and/or started entering text in the language to begin developing a crowd-sourced language model. If the chosen language is new, the process continues in step 308, where the system collects information about the new language. As described above, such information may include, for example, alternative names for the language, and locations where the language is used (e.g., geofenced GPS coordinates). The system may collect information about the location of the user's device(s) and associate that location with the selected language. The system also collects information about the character set that the user wishes to use for the selected language, and allows the user to choose a keyboard for entering text in that character set. As described above, the system may provide a mechanism for the user to edit a new or existing keyboard. At step 309, the system associates the chosen character set and keyboard with the selected language. As described above, for languages that are not written primarily using Latin script, some users may choose to enter transliterated text in a non-native character set (e.g., Latin characters), while others may choose to use the native characters. The system may associate more than one character set and keyboard with the selected language, or may treat similarly or identically named languages using different character sets as separate, whether they are presented separately or under a single name to the user.

At step 310, the system initializes a new language model based on the information collected in steps 308-309. Typically the system initializes a new language model 171 with an empty static portion 171a. As described above, however, in some cases the technology allows the user to specify a similar known language that the user indicates has at least some related vocabulary, or the technology identifies and provides a related language model or a portion of a language model (e.g., selected vocabulary) of a related base language. In some implementations of the technology, the system initializes the new language model with at least some words and word frequency data. In that case, the system may place all initial vocabulary and usage information into dynamic portion 171b for potential modification based on crowd-sourced language use data.

Returning to step 307, if the selected language is not new, the process continues to step 311. At step 311, the system determines one or more character sets and keyboards associated with the selected language. In some implementations of the technology, the system associates exactly one character set with a language model, so that, e.g., a user can select a Russian language model using Latin transliteration, or a separate Russian language model using Cyrillic characters. Optionally, at step 312, where the system associates more than one alternative keyboard and/or character set with a language model, the system allows the user to choose what character set(s) and keyboard(s) to use.

At step 313, the system provides a language model to the user, allowing the user to use the selected language with the user's device's language recognition system, and potentially contribute to the crowd-sourced development of the selected language. In some implementations, the technology provides a language model to multiple devices chosen by a user, so that the user is able to use the selected language across devices.

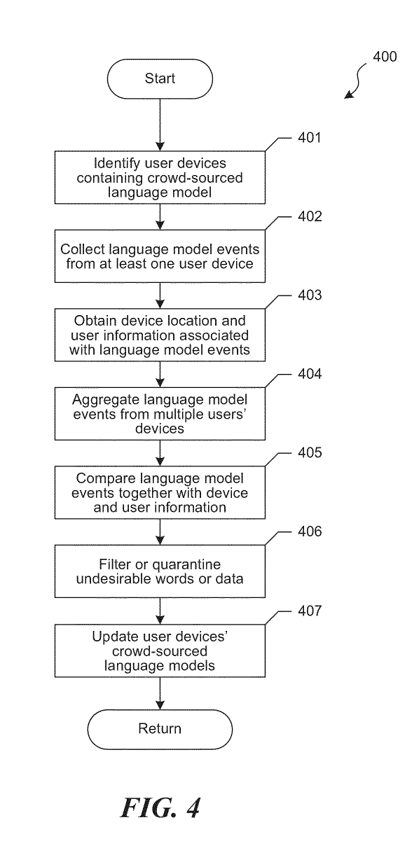

FIG. 4 is a flow diagram illustrating a set of operations for building a language model based on crowd-sourcing multiple users' language model events. At step 401, the system identifies user devices upon which a user has chosen to enter text in a language being developed in accordance with the technology. A server in the network can gather language data from devices registered with a service and devices identified by a distinguishing indicator (e.g., a globally unique identifier (GUID), a telephone number or mobile identification number (MIN), a media access control (MAC) address, or an Internet Protocol (IP) address). The system may identify users sharing the choice of a particular language. The system may also identify users having similar characteristics, such as location and/or similar language model contents or events.

At step 402, the system collects language model events for the selected language from at least one identified user device on which a user has used the language. In some implementations, a user can opt out of the system's collection of language model events from that user or from a specific user device. The system records changes to the language model based on events such as new words or n-grams, removed words or n-grams, and word/n-gram weight or frequency of use information received from the identified user device. In some implementations, the system surveys known devices associated with a particular language model on a regular basis. In some implementations, the system receives updates about a user's device's language model information occasionally when such information is available and a connection to the system is present, rather than on a defined or regular schedule. In some implementations of the technology, the system prompts updates to be transmitted by each device on a periodic or continuous basis. In some implementations, language model information is transmitted as part of a process to synchronize the contents of dynamic portion 171b with remotely hosted data (e.g., cloud-based storage) for backup and transfer to other databases. Language model processing system 162a and communication software 165 can send language model events individually, or in the aggregate, to the system 240. In some implementations, communication software 165 monitors the current connection type (e.g., cellular or Wi-Fi) and can make a determination as to whether events and updates should be transmitted to and/or from the device, possibly basing the determination on other information such as event significance and/or user preferences. In some implementations, language model events are processed in the order that they occurred, allowing the dynamic portion 171b to be updated in real time or near-real time. In some implementations, the system can process events out of order to update the dynamic portion. For example, more important events may be prioritized for processing before less important events.

The language model processing system 162a may selectively provide identified language model changes to other user computing devices. The language model changes may be provided, for example, to other users that fall within the group of users having selected a language and from whom the event data was received, or to new users that select the language. In some implementations, the language model processing system 162a aggregates or categorizes events and other information into a single grouping to allow communication software 165 to transmit the events and information to an external system (e.g., system 240 of FIG. 2). In some implementations, language model events are grouped as a category (e.g., based on the context in which the events occurred).

At step 403, the system obtains information associated with the collected language model events, including, for example, device location information and user information. Location data may be only general enough to specify the country in which the device is located (e.g., to distinguish a user in Japan from a user in the United States) or may be specific enough to indicate the user's presence at a particular event (e.g., within a stadium during or near the time of a sports event between teams from two different countries or regions with different languages). Location data may also include information about changes of location (e.g., arrival in a different city or country). Location data may be obtained from the user's device—a GPS location fix, for example—or from locale information set by the user. Obtained information may also include information about the context in which words were used, e.g., whether a particular word in a language is common in text messaging on a mobile device but rarely used in a word processing application on a personal computer.

At step 404, the system aggregates language model events or language model information for a language from multiple users. In some implementations, the technology aggregates entire language models from individual users. In some implementations, the technology updates a comprehensive language model using information about incremental changes or event logs in individual users' language models. The result of the aggregating is that the language model is based on data that describes multiple end user interactions with the corresponding devices of the end users using the language. By combining individual users' vocabularies and word usage patterns, the technology builds a broader crowd-sourced language model that reflects general usage among the participants more than it reflects individual peculiarities of language usage. In some implementations, the technology uses aggregated language model data to improve a speech recognition model for the language. For example, the technology may use the aggregated language model information to train, or to supplement data for training, a statistical language model in an automated speech recognition (ASR) system.

As described above, in some implementations, the technology requires words to have a threshold user count (e.g., at least a certain number or percentage of people using a given word or n-gram) and/or a threshold frequency of use (e.g., at least a certain number of times that the word or n-gram is used by each person who uses it, or a threshold for overall popularity of the word or n-gram by usage). By requiring a threshold breadth of usage (e.g., three or ten separate users), the technology improves the likelihood that a word is generally useful and avoids promulgating idiosyncratic words, erroneous spellings, and private information.

At step 405, the system compares individual users' language model contents and events along with device and user information collected from other devices and other users. In some implementations, the comparison considers the contexts of various local language model events, e.g., the type of device on which a user entered text, the mode in which text was entered (e.g., voice recognition, keyboard typing, or handwriting interpretation), or a user's differing vocabulary in different applications or uses such as Web search boxes, email prose, and map application searching; as well as indicia such as the size of the vocabulary used by a user and the user's respective propensity to profanity. The comparison may reveal that some users share vocabulary choices in particular contexts. The system may determine that users are sharing a particular dialect of a locale, recommend that a user select a more appropriate language model with greater similarity to the user's actual language use, or associate independently selected languages (e.g., “Chat speak” and “txt talk”) into a single language model. In some implementations, the technology applies different rules based on context or otherwise treats text entered in different contexts differently. For example, the technology may apply different treatment to words entered in an instant messaging application (e.g., SMS text, MMS, or other informal chat) where space is limited and users commonly use non-standard abbreviations (e.g., “u” for “you”). Such different treatment can include more caution in adding vocabulary, requiring a higher threshold to accept words, or less caution (e.g., allowing “b4” for “before”). It can also include creating a separate dictionary based on the context, or include setting flags or rules in the language model to permit use of alternate spellings or characters when a particular context is active or when similar terms are used in a context or on a particular device (e.g., when texting). The system may thus permit certain informal (mis)spellings in one context but not in another where users tend to be more formal, accurate, rigorous, or uniform in their spelling and vocabulary choices.

At step 406, the system filters or quarantines undesirable words or other language model data. As described above, the technology isolates uncommon word choices in favor of more broadly accepted vocabulary. Some words are held in quarantine temporarily until a usage threshold (by the user or among multiple users) is met. For example, the technology identifies patterns of user corrections and other language model events, together with the increased frequency of correctly spelled words compared to undesired spellings, to identify typographical errors (e.g., letter transpositions or nonstandard capitalization), other spelling corrections, and words that are typically not intended by users. In some implementations, the technology identifies words that users enter as the result of a correction or word change, and treats such explicit correction as a strong indicator that the resulting word is the correct word. The technology may also identify as reliable suggestions words that a user chooses from a list of suggested words. In some implementations, words or n-grams that are unused by most users and explicitly removed by a significant proportion of users who remove any words or n-grams from their language models are deleted from the language model. In some implementations, the filtering step 406 includes a blacklist of, e.g., misspellings (including capitalization and diacritical mark errors) and profanity, and a whitelist of basic vocabulary not to be deleted (e.g., the top five percent of commonly used words). The technology may crowd-source the blacklist of words never to be included in or suggested from a language model's vocabulary. The technology allows users to identify words as undesirable by deleting them from their individual language model, and can allow users to mark words, for example, as profanity, out-of-language words, or common misspellings. The technology may also filter based on a blacklist of words that should not be part of a language model for any language, including, e.g., malicious Website URLs. The filtering step 406 can also ensure that core vocabulary words are not improperly deleted from a language model, or that such changes are not promulgated to other users. In some implementations, the technology allows a user to adjust or customize the filtering, e.g., to turn it on or off completely, to change whether or how various types of filtering are performed, to modify its sensitivity, to add or remove patterns for filtering, or to limit or expand the contexts in which filtering is applied.

In some implementations, the filtering step 406 limits the overall size of the updates that may be sent to the user's device. Filtering criteria may include, e.g., a fixed number of words or n-grams, a maximum amount of data, a percentage of available or overall capacity for local language model data on the device, the number of words or n-grams required to obtain an accuracy rate better than a target miss rate (e.g., fewer than 1.5% of input words requiring correction), or any words or n-grams used at least a threshold number of times. In some implementations, a user may opt to modify filtering of the words to be added to the user's local language model on various criteria, e.g., how much free space to allocate to the crowd-sourced language model.

At step 407, the system updates individual users' language models with the aggregated and filtered crowd-sourced information, including added, removed, and/or changed word lists and frequency data. The system may vary the timing and extent of updates, which may include the entire updated language model or incremental updates to a user's language model. The technology may continuously provide updates to computing devices, may send updates in batches, may send updates when requested by a user, or may send updates when needed by the user (e.g., when a user changes to a particular language with a crowd-sourced language model). In some situations (e.g., due to poor connectivity or heavy usage), it may be impractical to consistently download language model changes to a device. In some implementations, the system selectively delivers some events and other information to the system 240 and receives some language model updates in real-time (or near real-time) in order to improve immediate prediction. Crowd-sourced vocabulary identified as relevant to the user's input improves the likelihood that the user will receive better word predictions from language recognition system 162.

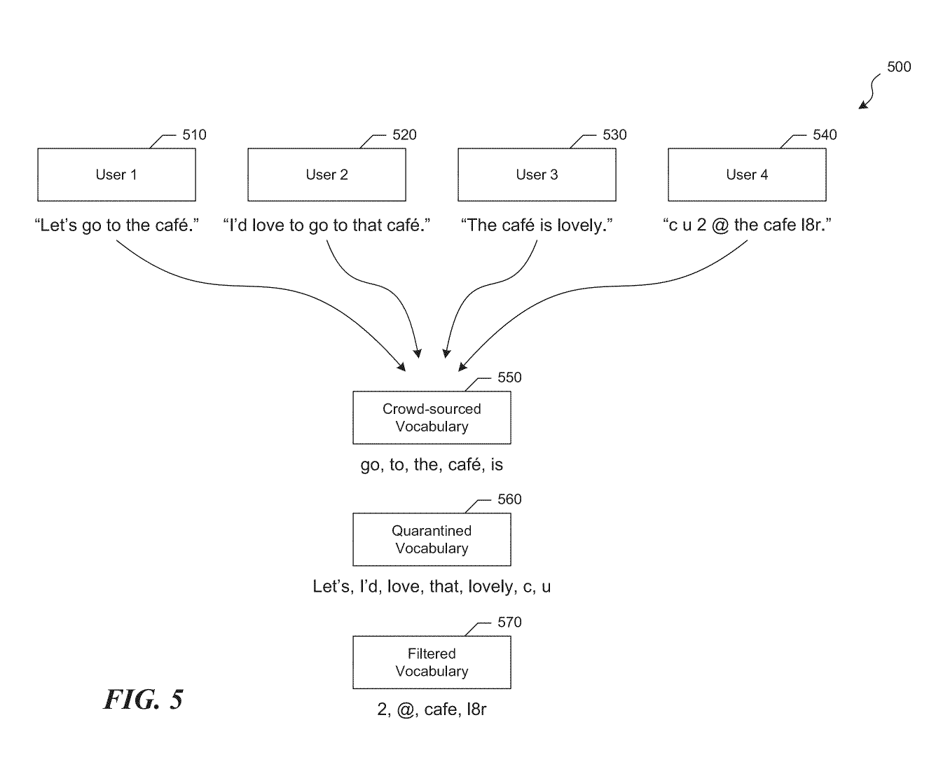

FIG. 5 is a diagram illustrating an example of language model updates based on text entered by multiple users. Users 510, 520, 530, and 540 enter text in a language associated with a crowd-sourced language model. Each of the users 510, 520, 530, and 540 have events on their devices related to text about a café (or several different cafés). Those language model events are collected and aggregated as described above in connection with FIG. 4. As illustrated, several of the commonly used words are added to the crowd-sourced vocabulary 550 that becomes part of the language model shared among the language users. In particular, words used by at least three users (“the”, “café”), words used at least three times among fewer than three users (“to”), and two-letter words (“go”, “to”, “is”, “at”) have been added to the crowd-sourced vocabulary 550 in this example. Words of more than two characters that are used by fewer than three users (“Let's”, “I'd”, “love”, “that”, “lovely”) and single-letter words or word abbreviations (“c”, “u”) are quarantined pending broader evidence that those words are commonly used. One word (“cafe”) has been filtered because it is an unaccented version of a common word used by all the other users and therefore is likely to be an incorrect form. In addition, words that contain numeric digits or symbols (“2”, “@”, “I8r”) have been filtered. In this example, after each user's population model has been updated to reflect the aggregated and filtered language model for the language, the crowd-sourced vocabulary words will be available to the language recognition systems of each of the users 510, 520, 530, and 540 as candidate words when those users input text in the language on their devices. The quarantined vocabulary words will be offered as candidates if they are used more, and the filtered vocabulary words will not be offered as candidates unless a user explicitly adds one or more of them to his or her language model.

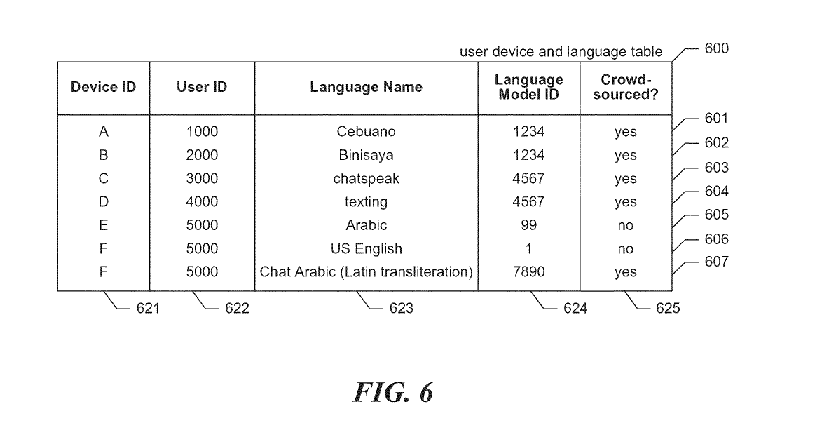

FIG. 6 is a table diagram showing sample contents of a user device and language table. The user device and language table 600 is made up of rows 601-606, each representing a device upon which a user has chosen a language for text entry. Each row is divided into the following columns: a device ID column 621 containing an identifier for an electronic device; a user ID column 622 containing an identifier for a user associated with the device; a language name column 623 containing the name of the language chosen by the user; a language model ID column 624 containing an identifier for the language model associated with the chosen language on the user's device; and a crowd-sourcing flag column 31 indicating whether the language model is being developed through crowd-sourcing according to an implementation of the technology.

For example, row 601 indicates that device A allows user 1000 to enter text in the Cebuano language, which uses the crowd-sourced language model 1234. Row 602 indicates that on device B, user 2000 can enter text in the Binisaya language, which uses the same crowd-sourced language model 1234. The table thus shows the technology associating two different languages or two different language names with one language model. Similarly, rows 603 and 604 indicate that on devices C and D, users 3000 and 4000 enter text in languages named “chatspeak” and “texting”, respectively, that share language model 4567. The table thus shows the technology crowd-sourcing development of a language model without requiring that the model correspond to a formal language. Rows 605, 606, and 607 show two devices E and F associated with a user 5000 who may enter text on device E in Arabic and on device F in US English or in transliterated Chat Arabic using Latin characters. The table thus shows the technology allowing a user to select different languages on one device, including both substantially complete language models and developing crowd-sourced language models.

Though the contents of user device and language table 600 are included to present a comprehensible example, those skilled in the art will appreciate that the technology can use a user device and language table having columns corresponding to different and/or a larger number of categories, as well as a larger number of rows. For example, a separate table may be provided for each language. Categories that may be used include, for example, various types of user data, language information, language model data (including, e.g., words and word frequencies, and quarantine information), language model metadata (e.g., language popularity statistics and thresholds for crowd-sourcing), and location data. Though FIG. 6 shows a table whose contents and organization are designed to make them more comprehensible by a human reader, those skilled in the art will appreciate that actual data structures used by the technology to store this information may differ from the table shown. For example, they may be organized in a different manner (e.g., in multiple different data structures); may contain more or less information than shown; may be compressed and/or encrypted; etc.

In some implementations, the technology includes determining that a language model is not available for a selected language, such that a language recognition system that uses a language model to predict words in a language is ineffective to predict intended words in the distinguished language; initializing a language model for the selected language, wherein the language model is based on text input from various computing devices provided by multiple users of the selected language, and wherein the language model is not based on data collected from a set of existing and stored documents in the selected language; monitoring use of words in the selected language by the user of the computing device; collecting, in the language model, information about the monitored use of the words in the selected language by the user of the computing device; providing to a server computer the collected information about the monitored use of the words in the selected language on the user of the computing device; and, receiving from the server computer updates to the language model based, in part, on the collected information about the monitored use of the words in the selected language by the user of the computing device, such that a language recognition system on the computing device and using the language model including the generated updates is more effective to predict intended words in the language.

### CONCLUSION

This application is related to U.S. application Ser. No. 14/106,635, filed on Dec. 13, 2013, entitled “Using Statistical Language Models to Improve Text Input”; U.S. application Ser. No. 13/869,919, filed on Apr. 24, 2013, entitled “Updating Population Language Models Based on Changes Made by User Clusters”; U.S. application Ser. No. 13/834,887, filed on Mar. 15, 2013, entitled “Subscription Updates in Multiple Device Language Models”; U.S. application Ser. No. 13/190,749, filed on Jul. 26, 2011, entitled “Systems and Methods for Improving the Accuracy of a Transcription Using Auxiliary Data Such as Personal Data”; U.S. Pat. No. 8,650,031, entitled “Accuracy Improvement Of Spoken Queries Transcription Using Co-Occurrence Information”; U.S. Pat. No. 8,543,384, entitled “Input Recognition Using Multiple Lexicons”; and U.S. Pat. No. 8,346,555, entitled “Automatic Grammar Tuning Using Statistical Language Model Generation”; which are each hereby incorporated by reference for all purposes and in their entireties.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list. The words “predict,” “predictive,” “prediction,” and other variations and words of similar import are intended to be construed broadly, and include suggesting word completions, corrections, and/or possible next words, presenting words based on no input beyond the context leading up to the word (e.g., “time,” “the ditch,” “her wound,” or “my side” after “a stitch in”) and disambiguating from among several possible inputs.

The above Detailed Description of examples of the disclosure is not intended to be exhaustive or to limit the disclosure to the precise form disclosed above. While specific examples for the disclosure are described above for illustrative purposes, various equivalent modifications are possible within the scope of the disclosure, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various examples described above can be combined to provide further implementations of the disclosure. Some alternative implementations of the disclosure may include not only additional elements to those implementations noted above, but also may include fewer elements.

These and other changes can be made to the disclosure in light of the above Detailed Description. While the above description describes certain examples of the disclosure, and describes the best mode contemplated, no matter how detailed the above appears in text, the disclosure can be practiced in many ways. Details of the system may vary considerably in its specific implementation, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

To reduce the number of claims, certain aspects of the disclosure are presented below in certain claim forms, but the applicant contemplates the various aspects of the disclosure in any number of claim forms. For example, while only one aspect of the disclosure is recited as a computer-readable memory claim, other aspects may likewise be embodied as a computer-readable memory claim, or in other forms, such as being embodied in a means-plus-function claim. (Any claims intended to be treated under 35 U.S.C. §112(f) will begin with the words “means for”, but use of the term “for” in any other context is not intended to invoke treatment under 35 U.S.C. §112(f).) Accordingly, Applicants reserve the right to pursue additional claims after filing this application to pursue such additional claim forms, in either this application or in a continuing application.

We claim:

1. A tangible computer-readable memory having contents configured to cause at least one computer having a processor to perform a method for assisting in building a new language model used by language recognition systems, the method comprising:
initializing a language model for a selected language,
wherein a language recognition system that uses a language model to predict words in a language is ineffective to predict intended words in the selected language;
monitoring use of words in the selected language on various computing devices by multiple users of the selected language;
collecting, in substantially real-time, information about the monitored use of the words in the selected language by the multiple users of the selected language;
generating updates to the language model based on the collected information about the monitored use of the words in the selected language; and
providing to the various computing devices the generated updates to the language model, such that a language recognition system using the language model including the generated updates is more effective to predict intended words in the selected language.

2. The computer-readable memory of claim 1, wherein generating updates to the language model based on the collected information about the monitored use of the words in the selected language includes adding words or n-grams to the language model or removing words or n-grams from the language model, modifying weighting or usage frequency data of words or n-grams in the language model.

3. The computer-readable memory of claim 1, wherein generating updates to the language model based on the collected information about the monitored use of the words in the selected language includes adding a word entered using characters from more than one language or script to the language model, or adding words entered by a first user using Latin characters and words entered by a second user using non-Latin characters to the language model.

4. The computer-readable memory of claim 1, wherein generating updates to the language model based on the collected information about the monitored use of the words in the selected language includes storing words in different character sets in different language models for the language, such that the updates to the language model are based on use of the selected language by users using words in a substantially similar character set.

5. The computer-readable memory of claim 4, wherein storing words in different character sets in different language models for the language includes storing words entered in a non-Latin script in a first language model for the language and storing words entered in a Latin script in a second language model for the language.

6. The computer-readable memory of claim 1, wherein generating updates to the language model based on the collected information about the monitored use of the words in the selected language includes requiring a threshold number or percentage of users to employ a word before adding that word to the language model.

7. The computer-readable memory of claim 6, wherein requiring a threshold number or percentage of users includes setting a lower threshold based on the size of the language model or the number of the multiple users of the selected language.

8. The computer-readable memory of claim 1, wherein generating updates to the language model based on the collected information about the monitored use of the words in the selected language includes filtering the collected information to identify words likely to contain errors, private information, or objectionable words.

9. The computer-readable memory of claim 8, wherein filtering the collected information to identify words likely to contain errors includes determining that the frequency that users of the selected language employ the correct word exceeds the frequency that users of the selected language employ the word containing the error, or treating word forms containing special characters as more authoritative than similar forms without special characters.

10. The computer-readable memory of claim 1, further comprising:
identifying two language models that have significant overlap in their word lists and word frequency distributions; and
aggregating the overlapping language models.

11. The computer-readable memory of claim 1, wherein providing to the various computing devices the generated updates to the language model includes providing the language model including at least some of the generated updates to a computing device of a new user of the language.

12. The computer-readable memory of claim 1, wherein:
initializing a language model for the selected language includes providing an empty language model containing no words in the language;
collecting, in substantially real-time, information about the monitored use of the words in the selected language by the multiple users of the selected language includes obtaining a language model containing about several hundred words in the language from a user; and
providing to the various computing devices the generated updates to the language model includes providing a language model containing about several thousand words in the language.

13. A method in a computing system of assisting in building a new language model used by a language recognition system to predict words in a language, the method comprising:
distinguishing a language;
determining whether a substantially complete language model is available for the distinguished language;
when a substantially complete language model is not available for the distinguished language,
monitoring, on the computing system, use of words in the distinguished language by a user of the computing system substantially in real time;
collecting, in a language model on the computing system, information about the monitored use of the words in the distinguished language;
receiving updates to the language model on the computing system based on additional information about use of words in the distinguished language by other users of the distinguished language monitored substantially in real time; and
predicting in response to user input, by the language recognition system, a word in the distinguished language intended by the user,
wherein the predicting is based on the information in the language model, including the information about the monitored use of words in the distinguished language and the additional information collected from other users of the distinguished language.

14. The method of claim 13, wherein distinguishing a language includes:
obtaining information about the location of the user or computing system;
identifying at least one language used in locations including or near the obtained location; and
automatically determining a language of user text input based on comparing characteristics of the user text input to characteristics of an identified language; or
providing for user selection, based on the obtained location information and the language identification, the name of at least one identified language and receiving a user selection of a language name.

15. The method of claim 13, wherein distinguishing a language includes:
receiving a user input language name;
comparing the received user input language name to the contents of a data structure containing recognized language names, including names for languages in English and in native scripts;
determining, based on the comparing, that the received user input language name does not correspond to a recognized language name; and
prompting the user to select a name of a language similar to or related to the received user input language name, such that at least one other user has selected the language; or to provide alternate names of the user input language and to select a keyboard or a character set for the user input language, and adding the received user input language name to the contents of the data structure.

16. The method of claim 15, further comprising associating at least a portion of a language model with a plurality of languages or with a plurality of language names.

17. The method of claim 13, wherein determining that a substantially complete language model is not available for the selected language includes determining that no language model is available for the selected language, that a language model for the selected language has not been completely developed, or that a language model for the selected language contains fewer than about several hundred words.

18. The method of claim 13, further comprising:
initializing a substantially empty language model, downloading a not completely developed language model based on word usage information from other users, downloading a language model containing fewer than about several hundred words, or downloading a language model containing words from a different language; and
providing or designating a keyboard or a character set for the language.

19. The method of claim 18, wherein providing or designating a keyboard or a character set for the language includes:
determining a keyboard chosen by most users of the language or a keyboard edited by a user of the language; and
presenting the determined keyboard as a default choice for the language.

20. The method of claim 13, wherein monitoring, on the computing system, use of words in the distinguished language by a user of the computing system substantially in real time includes:
monitoring words explicitly added to a user dictionary or language model; or;
receiving a user selection of a block of text and an indication that the text is in the language; and
scanning the selected text, such that the words in the selected text or information about the words in the selected text is collected in the language model for the language on the computing system.

21. The method of claim 13, wherein information about the monitored use of words in the selected language includes words and frequencies of individual words, word pairs (bigrams), triplets (trigrams), or higher-order n-grams, and information about responses to word suggestions and deletions of words from the language model.

22. A system for assisting in building a language model used by a language recognition system to predict words in a language, the system comprising:
at least one memory storing computer-executable instructions of:
a component configured to associate a crowd-sourced language model with the language;
for one of multiple computing devices:
a component configured to identify user input of words on the computing device as use of words in the language;
a component configured to monitor use of words in the language on the computing device substantially in real time;
a component configured to collect, in the crowd-sourced language model, information about the monitored use of the words in the distinguished language on the multiple computing devices;
a component configured to generate updates to the crowd-sourced language model based on the collected information about the monitored use of the words in the language; and
a component configured to provide to each of the multiple devices the generated updates to the language model; and
at least one processor for executing the computer-executable instructions stored in the at least one memory.

23. The system of claim 22, wherein the component configured to collect, in the crowd-sourced language model, information about the monitored use of the words in the distinguished language on the multiple computing devices is configured to receive a language model or information about changes to a language model from each of the multiple computing devices.
